(19) United States
(12) Patent Application Publication
(10) Pub. No.: US 2026/0312974 A1
(43) Pub. Date: Oct. 8, 2026

(54) DETECTING MALICIOUS URLS RELATED TO MALICIOUS URL CAMPAIGNS

(71) Applicant: Palo Alto Networks, Inc., Santa Clara, CA (US)

(72) Inventors: Peng Peng, San Jose, CA (US); Mohamed Yoosuf Mohamed Nabeel, San Jose, CA (US); Fang Liu, College Station, TX (US); Oleksii Starov, Sunnyvale, CA (US); Joe Larry Allen, III, Santa Clara, CA (US)

(21) Appl. No.: 19/173,490

(22) Filed: Apr. 8, 2025

(51) Int. Cl. H04L 9/40

(52) U.S. Cl. CPC H04L 63/1425; H04L 63/0236; H04L 63/1441

(57) ABSTRACT

A malicious URL campaign identification service clusters pooled embeddings of malicious URLs inferred to be associated with malicious campaigns. For groups of malicious URLs that correspond to a same cluster and therefore a same inferred campaign, the campaign identification service generates a pattern(s) and an embedding representing the cluster. The generated pattern(s) and cluster embedding generated for each cluster (and therefore campaign) are stored for inline detection of URLs associated with a campaign. An inline detector determines if a URL identified in network traffic matches any of the generated patterns. If a match is not found, the inline detector generates a pooled embedding of the URL and determines if the pooled embedding is sufficiently similar to any of the cluster embeddings. If the URL matches a pattern or if the pooled embedding is sufficiently similar to a cluster embedding, the inline detector indicates that the URL corresponds to a campaign.

### BACKGROUND

The disclosure generally relates to data processing (e.g., CPC subclass G06F) and to security arrangements for protecting computers, components thereof, programs, or data against unauthorized activity (e.g., CPC subclass G06F 21/00)

A cyberthreat campaign, sometimes “malicious campaign,” is an organized set of activities to achieve a cyberthreat purpose or goal (e.g., data exfiltration, unauthorized device/network access, fraud, etc.). A typical delivery mechanism for a cyberthreat campaign is websites. Thus, a cyberthreat campaign that leverages websites uses a variety of uniform resource locators (URLs). Threat actors leverage URLs for phishing campaigns, malware delivery campaigns, data harvesting campaigns, etc. These are sometimes referred to as malicious URL campaigns.

### BRIEF DESCRIPTION OF THE DRAWINGS

Embodiments of the disclosure may be better understood by referencing the accompanying drawings.

FIG. 1 is a conceptual diagram of generating clusters representing inferred malicious URL campaigns and creating patterns for detecting URLs associated with those malicious URL campaigns.

FIG. 2 is a conceptual diagram of inline detection of URLs associated with a malicious URL campaign.

FIGS. 3A-3B are a flowchart of example operations for identifying malicious URLs that correspond to inferred malicious URL campaigns.

FIG. 4 is a flowchart of example operations for performing inline detection of malicious URLs associated with a campaign.

FIG. 5 is a flowchart of example operations for generating a pooled embedding from a URL.

FIG. 6 is a flowchart of example operations for generating PCREs for detecting URLs corresponding to a campaign based on prompting a language model.

FIG. 7 depicts an example computer system with a malicious URL campaign identification service and a malicious campaign-associated URL detector.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Detection of malicious URL campaigns can be challenging since known campaigns can leverage evolving URL patterns for carrying out malicious activity. Additionally, many “patient zero” URLs that are slight variations of known malicious URLs may go undetected in early stages of their release. Disclosed herein are techniques for detecting URLs associated with a malicious URL campaign, including such patient zero URLs. A malicious URL campaign identification service performs initial batch processing of known malicious URLs to cluster embeddings of malicious URLs suspected to be associated with malicious URL campaigns. Each malicious URL embedding is generated from pooling a plurality of embeddings that capture different characteristics of the URL (e.g., semantic characteristics, word-level characteristics, and character-level characteristics). For groups of malicious URLs that correspond to a same cluster and therefore a same suspected malicious URL campaign, the campaign identification service generates a pattern(s) (e.g., a regular expression(s)) and a cluster embedding, or an embedding representing the cluster. The generated pattern(s) and cluster embedding generated for each cluster (and therefore campaign) are stored for inline detection of URLs associated with a malicious URL campaign.

In an inline detection stage, an inline detector leverages the generated patterns and cluster embeddings to detect URLs identified in network traffic likely associated with a malicious URL campaign. The inline detector determines if a URL identified in network traffic matches any of the patterns generated for the malicious URLs inferred to correspond to campaigns. If a match is identified, the inline detector indicates that the URL corresponds to a malicious URL campaign, and the associated network traffic can thus be blocked. If a match is not found, the inline detector generates a pooled embedding of the URL (similar to how the campaign identification service generated the URL embeddings that were clustered) and determines if the pooled embedding is sufficiently similar to any of the cluster embeddings, in which case the URL is determined to be associated with a malicious URL campaign, and the corresponding network traffic can be blocked. The two-stage approach to malicious URL campaign detection that combines a rapid pattern-based approach and a flexible embedding-based approach ensures a comprehensive evaluation of identified URLs without incurring unnecessary cost.

### Example Illustrations

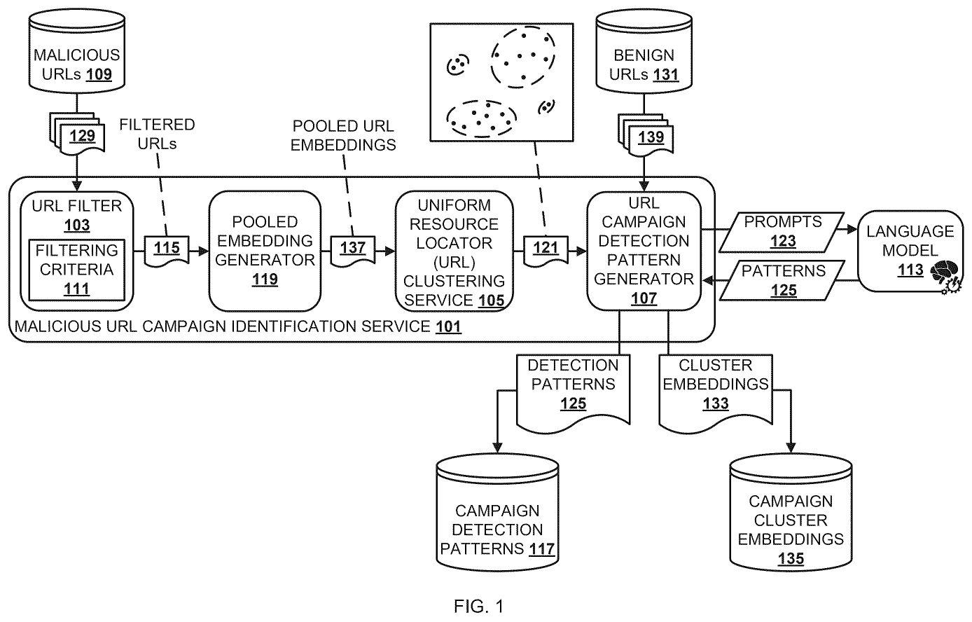

FIG. 1 is a conceptual diagram of generating clusters representing inferred malicious URL campaigns and creating patterns for detecting URLs associated with those malicious URL campaigns. A malicious URL campaign identification service (“service”) 101 infers that groups of known malicious URLs correspond to malicious URL campaigns based on clustering of URL embeddings. For each group of URLs inferred to correspond to a malicious URL campaign, the service 101 generates an embedding representing the cluster and a pattern(s) (e.g., a regular expression(s), such as Perl Compatible Regular Expressions (PCREs)) for detecting URLs that likely correspond to the malicious URL campaign.

The service retrieves malicious URLs 129 from a malicious URL repository 109. The malicious URLs 129 have already been determined to be malicious, such as based on expert/domain knowledge, previous classification as malicious by a cybersecurity appliance (e.g., a firewall) or a machine learning model trained to classify URLs as malicious or non-malicious, etc. A URL filter 103 of the service 101 filters the malicious URLs 129 based on filtering criteria 111 to determine those that are suspected to be associated with a malicious URL campaign. The filtering criteria 111 may include a criterion that a malicious URL includes a path and/or a query string, as URLs with a path and/or query string are more likely to correspond to a malicious URL campaign than those that lack both URL components. As another example, the filtering criteria 111 may include a criterion that the domain name identified in a malicious URL is not generated by a domain generation algorithm (DGA). The URL filter 103 can comprise one or more patterns (e.g., regular expressions) that match URLs likely comprising DGA-generated domain names, can leverage a DGA domain name detector for evaluating the malicious URLs 129, etc. The URL filter 103 filters the malicious URLs 129 based on these filtering criteria 111 to yield filtered URLs 115, which are those the malicious URLs 129 that satisfy the filtering criteria 111 (e.g., those that comprise a path and/or query string and/or do not comprise a DGA-generated domain name).

A pooled embedding generator (“embedding generator”) 119 of the service 101 generates pooled embeddings of the filtered URLs 115. The embedding generator 119 generates, for each of the filtered URLs 115, a plurality of embeddings of the URL and transforms the plurality of embeddings to generate a pooled embedding for the URL. For instance, the embedding generator 119 can generate a text embedding, an embedding based on term frequency-inverse document score (TF-IDF), and an embedding of n-grams (e.g., bigrams) of the URL and transforms the generated embeddings with max pooling or average pooling. Generating a text embedding, TF-IDF embedding, and n-grams embedding of a URL captures semantic features, word-level characteristics, and character-level characteristics of the URL.

To generate the text embedding of each of the filtered URLs 115, the embedding generator 119 leverages a text embedding model, such as a sentence transformer (e.g., a Bidirectional Encoder Representations from Transformers (BERT) model), a doc2vec model, etc. To generate the TF-IDF embedding of the filtered URLs 115, the embedding generator 119 can parse each of the URLs into tokens based on one or more delimiters of the URL (e.g., “.”, “/”, “?”, etc.) and compute the TF-IDF for each token, where the TF is computed for the token relative to its originating URL and the IDF is computed for the token relative to tokens across the filtered URLs 115 that have been parsed. The embedding generator 119 then stores, for each of the filtered URLs 115, the TF-IDF scores computed for the URL in a vector. To generate the n-grams embedding of each of the filtered URLs 115, the embedding generator 119 generates n-grams of each URL (e.g., bigrams) and generates a text embedding of the n-grams with a text embedding model. Embedding models that the embedding generator 119 leverages can be open-source and/or off-the-shelf models. Alternatively, or in addition, the embedding generator 119 can leverage proprietary embedding models.

For each set of embeddings generated for one of the filtered URLs 115, the embedding generator 119 reduces the dimensionality of the embeddings (e.g., with Uniform Manifold Approximation and Projection (UMAP), principal component analysis (PCA), or singular value decomposition (SVD)) to normalize the embeddings and pools the embeddings to generate a pooled embedding. The embedding generator 119 can pool the embeddings with max pooling or average pooling. Pooling the embeddings across the filtered URLs 115 yields pooled URL embeddings 137, where each of the pooled URL embeddings 137 represents a corresponding one of the filtered URLs 115.

A URL clustering service 105 of the service 101 clusters the pooled URL embeddings 137 representing the filtered URLs 115. The URL clustering service 105 clusters the pooled URL embeddings 137 into clusters with an unsupervised learning clustering algorithm, such as Hierarchical Density-Based Spatial Clustering of Applications with Noise (HDBSCAN). The URL clustering service 105 can be configured with one or more clustering parameters, such as minimum cluster sizes. Clusters 121 that result from clustering comprise indications of cluster membership for at least a subset of the pooled URL embeddings 137, indications of corresponding ones of the filtered URLs 115, and cluster metrics (e.g., cluster sizes, cluster centroids, etc.). Each of the clusters 121 can be inferred to correspond to a malicious URL campaign, with those of the filtered URLs 115 having an embedding that is a member of that cluster inferred to be associated with that campaign.

A pattern generator 107 of the service 101 generates detection patterns (“patterns”) 125 for detecting URLs that correspond to an inferred malicious URL campaign represented in the clusters 121. The pattern generator 107 retrieves benign URLs 139 from a benign URL repository 131. The benign URLs 139 have already been determined to be benign, such as based on expert/domain knowledge, previous classification as benign by a cybersecurity appliance or a trained machine learning model, etc. The pattern generator 107 leverages a combination of pattern generation tools and generative artificial intelligence (AI) to generate the patterns 125. To generate a first subset of the patterns 125 with generative AI, the pattern generator 107 constructs prompts 123 that comprise subsets of the filtered URLs 115 and benign URLs 139. The pattern generator 107 is configured with a prompt template that comprises placeholders for malicious URLs, benign URLs, and a task instruction to generate a PCRE (or other regular expression) that matches the malicious URLs but do not match the benign URLs. The pattern generator 107 submits each of the prompts 123 to a language model 113 to obtain the patterns 125 in responses from the language model 113. To generate a second subset of the patterns 125 with a pattern generation tool(s), the pattern generator 107 leverages an off-the-shelf, open-source, etc. pattern generator(s) (not depicted in FIG. 1), such as a PCRE generation tool/library that is publicly available. For this case, the pattern generator 107 provides at least a subset of the filtered URLs 115 as strings to which generated pattern(s) should match and can validate the generated pattern(s) based on the benign URLs 139. The pattern generator 107 stores the patterns 125 in a database of campaign detection patterns 117.

The pattern generator 107 also determines cluster embeddings 133 representing the clusters 121. For each of the clusters indicated in the clusters 121, the pattern generator 107 determines an embedding that represents the cluster. For instance, the pattern generator can select the centroid of the cluster as the cluster embedding. The pattern generator 107 stores the cluster embeddings 133 in a database of cluster embeddings 135.

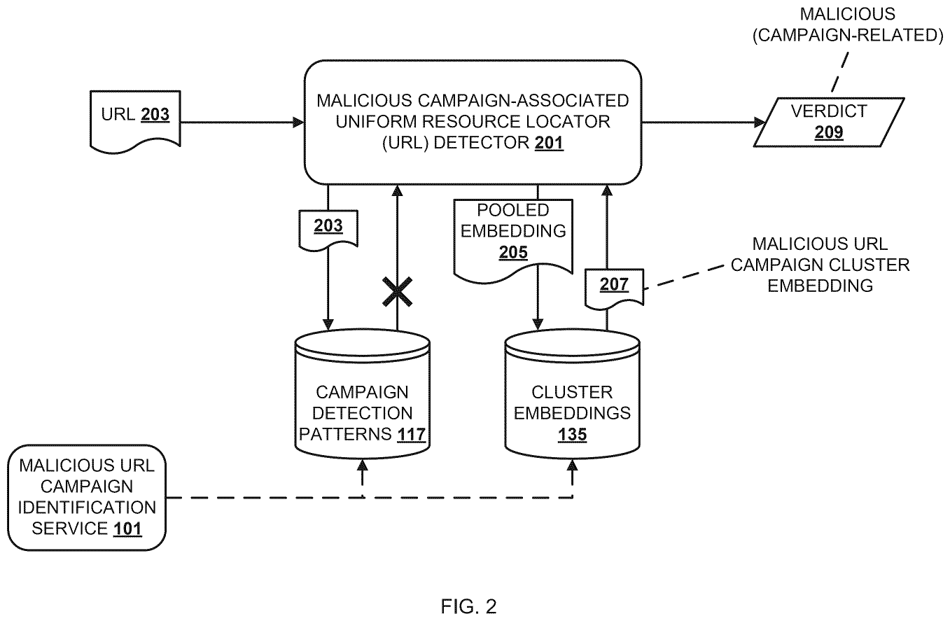

FIG. 2 is a conceptual diagram of inline detection of URLs associated with a malicious URL campaign. FIG. 2 depicts the detection patterns 117 and cluster embeddings 135 databases populated by the service 101 as described in reference to FIG. 1. The service 101 is depicted as maintaining a connection to the detection patterns 117 and cluster embeddings 135 databases to indicate that generation of additional detection patterns and/or cluster embeddings and insertion thereof into the respective one of the databases can be ongoing and independent of inline detection operations.

FIG. 2 depicts a malicious campaign-associated URL detector (“detector”) 201. The detector 201 performs inline (i.e., in the path of flow of network traffic in contrast with out-of-band) detection of URLs suspected to be associated with a malicious URL campaign. The detector 201 can execute as a cloud-based service with which a cybersecurity appliance communicates, as a service of a cybersecurity appliance, etc. The detector 201 maintains or has access to the detection patterns 117 and cluster embeddings 135 databases.

The detector 201 obtains a URL 203. The URL 203 may have been identified in network traffic detected by a cybersecurity appliance and forwarded to the detector 201. The detector 201 first searches the detection patterns 117 with the URL 203 to determine if the URL 203 matches any of the patterns that have been defined for malicious URL campaign detection. In this example, as a result of a lookup in the detection patterns 117 with the URL 203, the detector 201 determines that there is not a pattern to which the URL 203 matches.

The detector 201 then generates a pooled embedding 205 from the URL 203. The detector 201 generates the pooled embedding 205 by generating a plurality of embeddings (e.g., a text embedding, a TF-IDF embedding, and an n-grams embedding), normalizing the embeddings, and pooling the generated embeddings with max pooling or average pooling as similarly described in reference to FIG. 1. The detector 201 searches the cluster embeddings 135 for a cluster embedding that is sufficiently similar to the pooled embedding 205. Whether a cluster embedding is sufficiently similar to the pooled embedding 205 can be based on a similarity score between the embeddings satisfying a threshold with which the detector 201 is configured. For instance, a cluster embedding and the pooled embedding 205 can be considered sufficiently similar if a cosine similarity computed for the embeddings satisfies a threshold (e.g., a threshold of 0.9 or 0.95). This example assumes that the pooled embedding 205 is sufficiently similar to a malicious URL campaign cluster embedding 207 maintained in the cluster embeddings 135.

The detector 201 generates a verdict 209 indicating that the URL 203 is malicious due to being related to an inferred malicious URL campaign. The detector 201 can indicate the verdict 209 to the cybersecurity appliance that detected the URL 203 so that the associated network traffic can be blocked, quarantined for further analysis, etc.

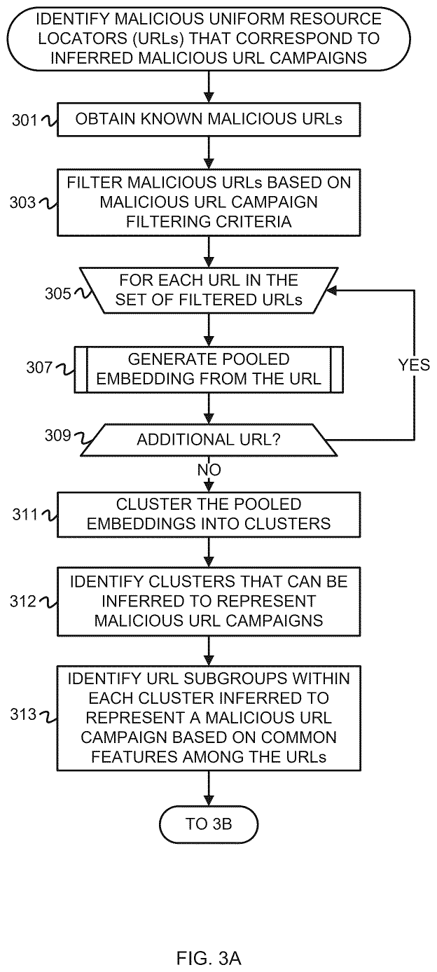

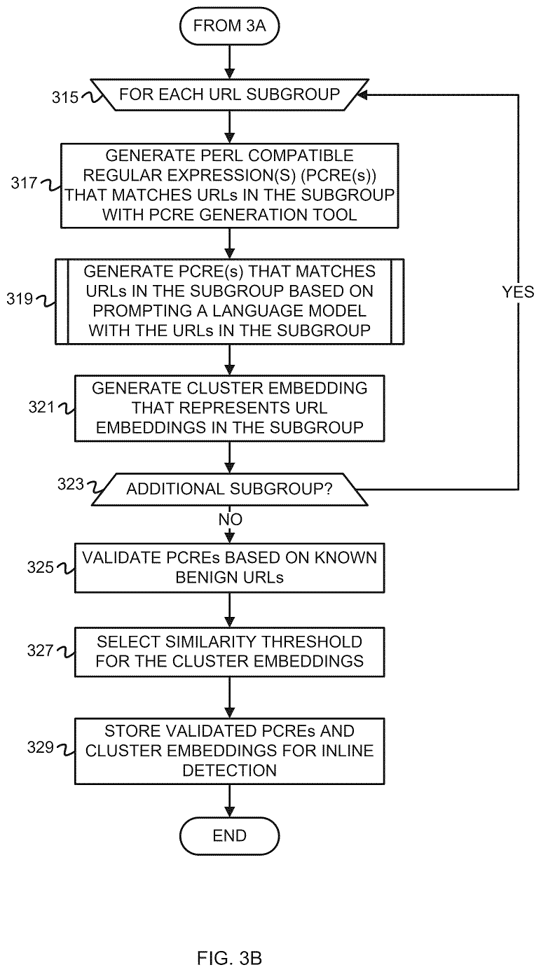

FIGS. 3A-6 are flowcharts of example operations. The example operations are described with reference to a malicious URL campaign identification service (“the campaign identification service”) and a malicious campaign-associated URL detector (“the detector”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIGS. 3A-3B are a flowchart of example operations for identifying malicious URLs that correspond to inferred malicious URL campaigns. The example operations are described with reference to the campaign identification service.

At block 301, the campaign identification service obtains known malicious URLs. The known malicious URLs are URLs that have been previously classified as/determined to be malicious. The campaign identification service retrieves the known malicious URLs from a repository or other data store that maintains malicious URLs.

At block 303, the campaign identification service filters the malicious URLs based on one or more malicious URL campaign filtering criteria. The filtering criteria are based on heuristics for determining URLs that are more likely to correspond to a malicious URL campaign. The filtering criteria can include a criterion that a URL should have a path and/or query string, a criterion that a domain name of a URL should not be DGA-generated, etc. URLs that do not satisfy the filtering criteria are filtered out from subsequent operations.

At block 305, the campaign identification service begins iterating over URLs in the set of filtered URLs. The filtered URLs are those that satisfied the filtering criteria (e.g., URLs that comprise a path and/or query string).

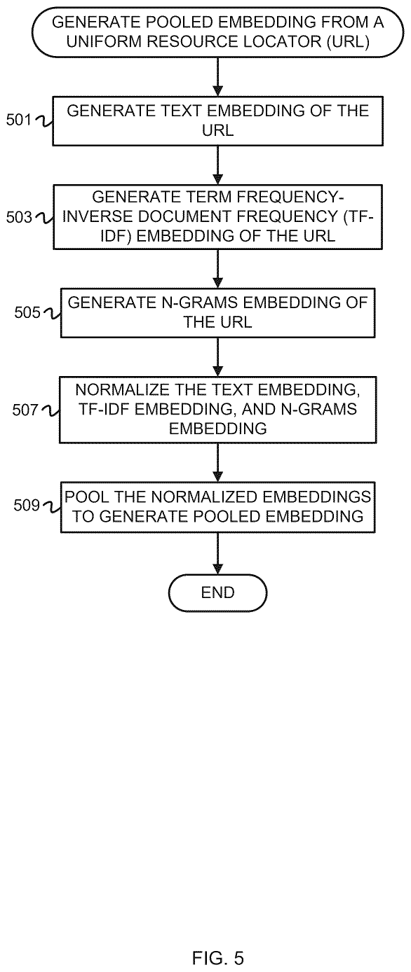

At block 307, the campaign identification service generates a pooled embedding from the URL. The campaign identification service generates a plurality of embeddings of the URL that can include embeddings capturing semantic characteristics, word-level characteristics, and character-level characteristics of the URL. The campaign identification service reduces dimensionality of the generated embeddings and inputs the reduced-dimensionality embeddings into a pooling layer, such as a max pooling layer or an average pooling layer, to generate a pooled embedding for the URL. Generating a pooled embedding from a URL is described in further detail in reference to FIG. 5.

At block 309, the campaign identification service determines if there is an additional URL. If so, operations continue at block 305. Otherwise, operations continue at block 311.

At block 311, the campaign identification service clusters the pooled embeddings into clusters. The campaign identification service clusters the pooled embeddings according to an unsupervised clustering algorithm, such as HDBSCAN. Each pooled embedding in a resulting cluster corresponds to a URL that is indicated as a label, tag, etc. associated with the embedding.

At block 312, the campaign identification service identifies at least a subset of the clusters that can be inferred to represent malicious URL campaigns. The campaign identification service evaluates the resulting clusters based on criteria for inferring that a cluster of URLs corresponds to a malicious URL campaign. The criteria can comprise a size criterion, such as a threshold indicating a minimum size of the cluster for inferring the cluster corresponds to a malicious URL campaign (e.g., a size threshold of 50). Alternatively, or in addition, the criteria can comprise a criterion for the URLs represented in the cluster, such as a threshold indicating a minimum number of domain names that should be represented in URLs of the cluster. To illustrate, the campaign identification service can determine that a cluster satisfies this criterion if the URLs represented in the cluster encompass at least ten different domain names. Clusters that do not satisfy the criteria can be disregarded during subsequent evaluation; if no clusters satisfy the criteria, operations can be terminated since there are no malicious URL campaigns that can be inferred from the clusters.

At block 313, the campaign identification service identifies URL subgroups within each cluster inferred to represent a malicious URL campaign based on common features among the URLs. Identifying subgroups within each URL group corresponding to a cluster that satisfied the criteria at block 312 facilitates generation of more specific detection patterns as will be described in later operations. The campaign identification service identifies URL subgroups within each group that have features in common, such as those that share domain names, path elements, and/or query string parameters. Clusters do not necessarily comprise multiple subgroups of URLs; in other words, a cluster may comprise one group of URLs that cannot be grouped further. Operations continue at block 315 of FIG. 3B.

At block 315, the campaign identification service begins iterating over URL subgroups. Each URL subgroup comprises a plurality of URLs, where the plurality of URLs corresponds to at least a subset of URLs associated with a respective cluster. In the event that one or more of the clusters were not further grouped into subgroups, the group of URLs of which each of these clusters is comprised is treated as a subgroup for the purpose of the example operations.

At block 317, the campaign identification service generates at least a first PCRE that matches URLs in the subgroup with a PCRE generation tool. The campaign identification service leverages an off-the-shelf, open-source, or proprietary PCRE generation tool to generate one or more PCREs that match the URLs in the subgroup.

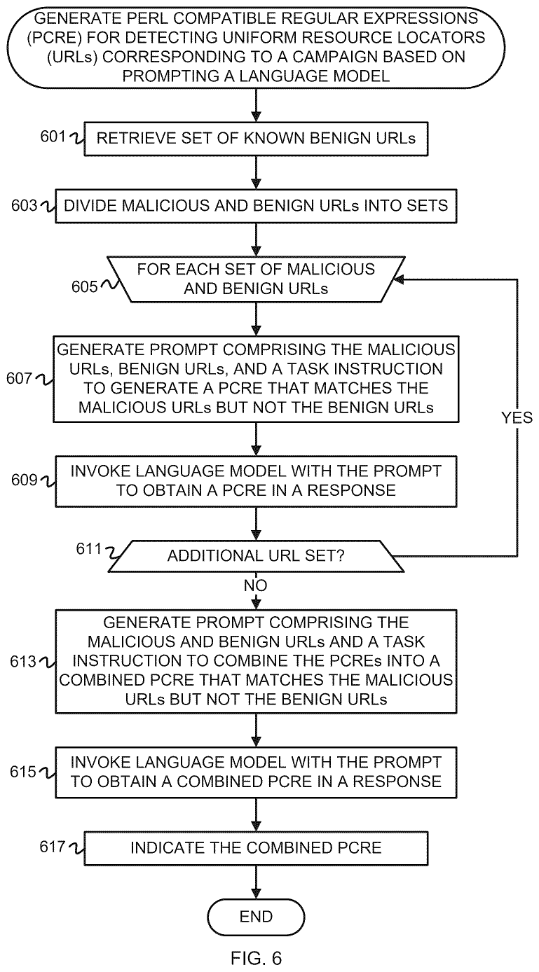

At block 319, the campaign identification service generates at least a first PCRE that matches URLs in the subgroup based on prompting a language model with the URLs in the subgroup. The campaign identification service generates a prompt comprising the URLs in the subgroup as well as known benign URLs and a task instruction to generate a PCRE that matches the malicious URLs in the subgroup but does not match the benign URLs. The campaign identification service submits the prompt to the language model (e.g., an LLM) to obtain output comprising the PCRE, which it may further validate through additional prompting. Generation of PCREs by prompting a language model is described in further detail in reference to FIG. 6.

At block 321, the campaign identification service generates a cluster embedding that represents the URL embeddings in the subgroup. For clusters that did not include multiple subgroups of URLs, the campaign identification service can select the cluster's centroid as the cluster embedding representing the URLs in the cluster. Otherwise, the campaign identification service can compute the average of the pooled embeddings corresponding to the subgroup and select the computed average as the cluster embedding.

At block 323, the campaign identification service determines if there is an additional subgroup remaining across clusters. If there is another subgroup, operations continue at block 315. If not, operations continue at block 325.

At block 325, the campaign identification service validates the generated PCREs. The campaign identification service validates the PCREs based on known benign URLs to ensure that the PCREs do not match any benign URLs. Those of the PCREs that do not match any of the known benign URLs can be determined to be valid.

At block 327, the campaign identification service selects a similarity threshold for the cluster embeddings. The similarity threshold is the threshold for a similarity score (e.g., cosine similarity) based on which pooled embeddings generated from URLs are evaluated to determine if a pooled embedding is sufficiently similar to a cluster embedding. The similarity threshold should be selected such that pooled embeddings representing a sufficient proportion (e.g., more than 75%) of malicious URLs in the same subgroup are determined to be sufficiently similar to the corresponding cluster embedding, but no malicious URLs corresponding to other subgroups should be considered sufficiently similar to the cluster embedding based on the similarity threshold. In other words, similarity scores computed for a cluster embedding and at least a threshold number of pooled embeddings within the corresponding URL subgroup should satisfy the similarity threshold, but similarity scores between the cluster embedding and pooled embeddings corresponding to other subgroups should not satisfy the similarity threshold. Additionally, the similarity threshold(s) should be configured such that pooled embeddings representing the known benign URLs are not found sufficiently similar to any of the cluster embeddings. Similarity thresholds can also be selected for each cluster embedding individually based on the similarity threshold selection criteria; as a result, similarity thresholds can differ across the cluster embeddings. The similarity threshold can be associated with each cluster embedding (e.g., as metadata) or can be indicated in a notification, report, etc. for configuration of the inline detector.

At block 329, the campaign identification service stores the validated cluster embeddings and PCREs for inline detection. The campaign identification service stores the cluster embeddings and PCREs determined to be valid in respective data stores (e.g., databases/repositories) that can be accessed by the detector for inline detection of malicious URLs corresponding to an inferred malicious URL campaign.

While FIGS. 3A-3B depict the example operations as occurring sequentially, in implementations, example operations may be performed in parallel or concurrently. For instance, the example operations corresponding to blocks 317, 319, and 321 can be performed in parallel/concurrently.

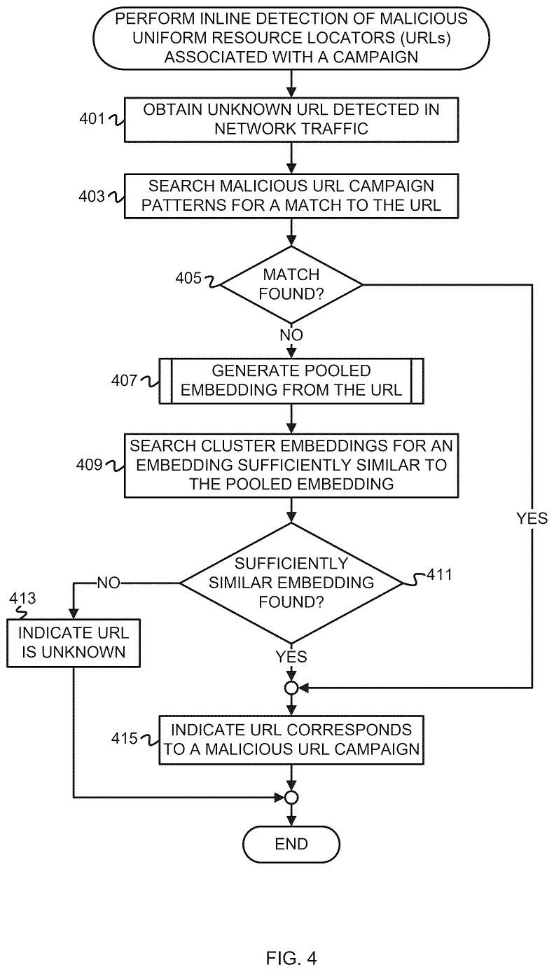

FIG. 4 is a flowchart of example operations for performing inline detection of malicious URLs associated with a campaign. The example operations are described with reference to the detector. The example operations assume that the detector has access to patterns (e.g., PCREs) and cluster embeddings generated as described above.

At block 401, the detector obtains an unknown URL detected in network traffic. The unknown URL may have been passed to the detector by a cybersecurity appliance that identified the URL in detected network traffic. The detector may be invoked for unknown URLs that are determined to comprise a path and/or query string. Implementations can also check a URL comprises a path and/or query string upon obtaining the URL, where operations continue if the URL is determined to comprise a path and/or query string.

At block 403, the detector searches malicious URL campaign patterns for a match to the URL. The malicious URL campaign patterns can include regular expressions, such as PCREs, which were generated as described in reference to FIGS. 3A-3B. The detector searches the generated patterns (e.g., the generated PCREs) with the URL to determine if there is a match to a pattern generated for detection of URLs associated with an inferred malicious URL campaign.

At block 405, the detector determines if a match was found between the URL and the patterns defined for malicious URL campaigns. If there was not a match, operations continue at block 407. If there was a match, operations continue at block 415.

At block 407, the detector generates a pooled embedding from the URL. Generating a pooled embedding from a URL is described in further detail in reference to FIG. 5.

At block 409, the detector searches the set of cluster embeddings for an embedding that is sufficiently similar to the pooled embedding. Whether embeddings are sufficiently similar can be based on a similarity score computed between the embeddings (e.g., a cosine similarity) satisfying a threshold. The threshold based on which the similarity scores between the pooled embedding and cluster embeddings are evaluated may have been configured as described in reference to FIG. 3B at block 327.

At block 411, the detector determines if a sufficiently similar embedding was found. If a sufficiently similarity embedding was not found, operations continue at block 413. If a sufficiently similar embedding was found, operations continue at block 415.

At block 413, the detector indicates that the URL is unknown. Because the URL did not match any patterns generated for detecting malicious URLs associated with an inferred campaign, and there was no cluster embedding sufficiently similar to the pooled embedding generated from the URL, the URL cannot be detected to be malicious and associated with a campaign. The detector can generate a notification, report, etc. to indicate (e.g., to the cybersecurity appliance) that the URL is unknown.

At block 415, the detector indicates that the URL corresponds to a malicious URL campaign. The detector can generate a notification, report, etc. indicating that the URL corresponds to a malicious URL campaign due to the URL either matching a pattern defined for an inferred malicious URL campaign or having a pooled embedding generated therefrom that is sufficiently similar to a cluster embedding generated for a cluster representing an inferred malicious URL campaign. The network traffic in which the URL was detected can subsequently be blocked due to the malicious verdict.

FIG. 5 is a flowchart of example operations for generating a pooled embedding from a URL. The example operations are described with reference to the campaign identification service for simplicity but can also be performed by the detector.

At block 501, the campaign identification service generates a text embedding of the URL. The campaign identification service leverages a text embedding model, such as a sentence transformer, a word2vec/doc2 vec model, etc. to generate a text embedding of the URL. The text embedding captures semantic features of the URL.

At block 503, the campaign identification service generates a TF-IDF embedding of the URL. The campaign identification service parses the URL into tokens based on one or more delimiters in the URL and computes a TF-IDF score for each token. The campaign identification service stores the TF-IDF scores generated for the tokens in respective elements of a vector to generate the TF-IDF embedding. The TF-IDF embedding captures word-level features of the URL. The campaign identification service also stores tokens and token statistics, such as the IDF values computed per token, to be leveraged during subsequent computation of TF-IDF scores from new URLs (e.g., during inline detection operations). In other words, the URLs processed during campaign inferencing as described above in reference to FIGS. 3A-3B are treated as the collection of documents based on which IDF scores are computed for tokens of newly detected URLs during inline detection operations.

At block 505, the campaign identification service generates an n-grams embedding of the URL. The campaign identification service generates n-grams of the URL, such as bigrams, and generates a text embedding of the n-grams representation of the URL with a text embedding model. The n-grams embedding captures character-level features of the URL.

At block 507, the campaign identification service normalizes the text embedding, TF-IDF embedding, and n-grams embedding. Normalization of the embeddings serves to ensure that embeddings that the campaign identification service generates are consistent in size. For instance, the campaign identification service can normalize the embeddings by reducing dimensionality of each embedding (e.g., with UMA, PCA, or SVD) to a given size. The designated size of each reduced-dimensionality embedding may be the same across embedding types or can differ across embedding types. The size(s) to which to reduce the dimensions of each embedding have been configured based on expert knowledge and/or prior experimentation.

At block 507, the campaign identification service pools the normalized embeddings to generate a pooled embedding. The campaign identification service pools the normalized embeddings with max pooling or average pooling to yield a pooled embedding representing the URL.

FIG. 5 describes various embedding techniques that are leveraged as part of generating a pooled embedding for a URL. Different and/or additional embedding techniques can be leveraged in implementations for generating pooled embeddings. Implementations are not limited to the embedding techniques described in the example operations. Additionally, while FIG. 5 depicts the example operations as occurring sequentially, in implementations, example operations may be performed in parallel or concurrently. For instance, the example operations corresponding to blocks 501, 503, and 505 can be performed in parallel/concurrently.

FIG. 6 is a flowchart of example operations for generating PCREs for detecting URLs corresponding to a campaign based on prompting a language model. The example operations assume that a group of URLs inferred to correspond to a malicious URL campaign have been identified (e.g., as described in reference to FIGS. 3A-3B). The example operations are described with reference to the campaign identification service.

At block 601, the campaign identification service retrieves a set of known benign URLs. The known benign URLs have been previously classified as/determined to be benign. The campaign identification service retrieves the known benign URLs from a repository or other data store that maintains benign URLs.

At block 603, the campaign identification service divides the malicious and benign URLs into sets. The campaign identification service randomly divides the malicious and benign URLs into N sets, where N is a configurable value.

At block 605, the campaign identification service iterates over the sets of malicious and benign URLs. Each of the sets comprises a subset of the malicious URLs inferred to correspond to a malicious URL campaign and a subset of the benign URLs.

At block 607, the campaign identification service generates a prompt comprising the malicious URLs in the set, the benign URLs in the set, and a task instruction to generate a PCRE that matches the malicious URLs but not the benign URLs. The campaign identification service can be configured with a prompt template that comprises placeholders for malicious and benign URL sets. The campaign identification service populates the placeholders with the respective sets of URLs. As part of generating the prompt, the campaign identification service can further split each of the sets of malicious and benign URLs into a training set and a testing set (e.g., with an 80/20 train/test split). An example of a prompt template for generating a PCRE based on sets of malicious and benign URLs is as follows:
“You are an expert of creating PCRE rules for malicious URLs.
I will give four URL lists, where URLs are split by new line.
There are four URL lists: TRAINING_MALICIOUS_URL_LIST, TRAINING_BENIGN_URL_LIST, TESTING_MALICIOUS_URL_LIST and TESTING_BENIGN_URL_LIST. You need to follow two steps to generate a PCRE rule with no false positives. That is, the PCRE rule should not match any URLS in TESTING_BENIGN_URL_LIST.
Step 1: Generate a concise PCRE rule that matches the URLs in the TRAINING_MALICIOUS_URL_LIST but does not match URLs in the TRAINING_BENIGN_URL_LIST. If the PCRE rule matches any of the URLs in the TRAINING_BENIGN_URL_LIST below, it is a false positive. Revise the PCRE rule to have no false positives. Remember the PCRE rule must match almost all URLs in TRAINING_MALICIOUS_URL_LIST and must not match any of the URLs in TRAINING_BENIGN_URL_LIST.
Please wait and think to make the PCRE rule as concise as possible.
TRAINING MALICIOUS URL LIST is as follows:
{training_malicious_url_list}
TRAINING BENIGN_URL_LIST is as follows:
{training_benign_url_list}
Step 2: Run the generated PCRE against two testing URL sets TESTING MALICIOUS URL LIST and TESTING BENIGN URL LIST.
TESTING MALICIOUS_URL_LIST is as Follows:
{testing_malicious_url_list}
Before returning the regex PCRE rule to me, always double check if it matches more than 80% of URLs in the TESTING_MALICIOUS_URL_LIST and exactly 0 match in the TESTING_BENGIN_URL_LIST.
Follow Step 1 first, then Step 2. Go back to Step 1 if Step 2 fails. Repeat the exercise maximum 5 times. If it still fails, return an error message in the following JSON format:

{
‘error’: Unable to generate a PCRE rule that detects more than 80% of the malicious
testing URLs. The maximum success rate is X%.
}
If you can achieve the above criteria within 5 iterations, please return the successful
result in the following JSON format.
{
‘Training malicious match’: ‘proportion of TRAINING_MALICIOUS_URL_LIST
URLS matching the PCRE rule’,
‘Training benign match’: ‘proportion of TRAINING_BENIGN_URL_LIST URLS
matching the PCRE rule’,
‘Testing malicious match’: ‘proportion of TESTING_MALICIOUS_URL_LIST URLs
matching the PCRE rule’,
‘Testing benign match’: ‘proportion of TESTING_BENIGN_URL_LIST URLs matching
the PCRE rule’,
‘PCRE rule’: ‘regex PCRE rule generated’
}

Please return only a JSON reply.”

At block 609, the campaign identification service invokes a language model with the prompt to obtain a PCRE in a response. The language model can be an open-source or closed-source LLM. Subsequent operations assume that the PCRE generation is a success, though the language model can output an error message, in which case no PCRE is obtained for consideration.

At block 611, the campaign identification service determines if there is an additional set of malicious and benign URLs for which to generate a PCRE. If so, operations continue at block 605. If not, operations continue at block 613.

At block 613, the campaign identification service generates a prompt comprising the malicious and benign URLs and a task instruction to combine the PCREs into a combined PCRE that matches the malicious URLs but not the benign URLs. The campaign identification service can be configured with another prompt template that comprises placeholders for malicious URLs, benign URLs, and a set of PCREs that the campaign identification service populates with the respective items. The malicious and benign URLs inserted into the prompt are the collection of malicious and benign URLs that were divided into sets at block 603. As part of generating the prompt, the campaign identification service can split each of the malicious and benign URL sets into a training set and a testing set. An example of a prompt template for combining PCREs into a combined PCRE is as follows:
“You are an expert of combining multiple PCRE rules for malicious URLs. The list of PCRE rules you are tasked with to combine are given below under the list CANDIDATE_PCRE_RULES.
In addition, I will give four URL lists, where URLs are split by new line.
There are four URL lists: TRAINING_MALICIOUS_URL_LIST, TRAINING_BENIGN_URL_LIST, TESTING_MALICIOUS_URL_LIST and TESTING_BENIGN_URL_LIST. You need to follow two steps to combine PCRE rules into one rule with no false positives. That is, the final PCRE rule should not match any URLs in TESTING_BENIGN_URL_LIST.
Step 1: Combine the PCRE rules in CANDIDATE_PCRE_RULES to one rule that matches the URLs in the TRAINING_MALICIOUS_URL_LIST but does not match URLs in the TRAINING_BENIGN_URL_LIST. If the combined PCRE rule matches any of the URLs in the TRAINING_BENIGN_URL_LIST below, it is a false positive. Revise the PCRE rule to have no false positives. Remember, the PCRE rule must match almost all URLs in TRAINING_MALICIOUS_URL_LIST and must not match any of the URLs in TRAINING_BENIGN_URL_LIST.
Please wait and think to make the PCRE rule as concise as possible. Please do not simply concatenate the rules to come up with the combined rule.
TRAINING_MALICIOUS_URL_LIST is as follows:
{training_malicious_url_list}
TRAINING_BENIGN_URL_LIST is as follows:
{training_benign_url_list}
Step 2: Run the combined PCRE rule against two testing URL sets TESTING_MALICIOUS_URL_LIST and TESTING_BENIGN_URL_LIST.
TESTING_MALICIOUS_URL_LIST is as Follows:

{testing_malicious_url_list}
Before returning the combined PCRE rule to me, always double check if it matches more
than 80% of URLs in the TESTING_MALICIOUS_URL_LIST and exactly 0 match in
the TESTING_BENIGN_URL_LIST.
Follow Step 1 first, then Step 2. Go back to Step 1 if Step 2 fails. Repeat the exercise
maximum 5 times. If it still fails, return an error message in the following JSON format:
{
‘error’: Unable to produce a combined PCRE rule that detects more than 80% of the
malicious testing URLs. The maximum success rate is X%.
}
If you can achieve the above criteria within 5 iterations, please return the successful
result in the following JSON format:
{
‘Training malicious match’: ‘proportion of TRAINING_MALICIOUS_URL_LIST
URLS matching the PCRE rule’,
‘Training benign match’: ‘proportion of TRAINING_BENIGN_URL_LIST URLS
matching the PCRE rule’,
‘Testing malicious match’: ‘proportion of TESTING_MALICIOUS_URL_LIST URLs
matching the PCRE rule’,
‘Testing benign match’: ‘proportion of TESTING_BENIGN_URL_LIST URLs matching
the PCRE rule’,
‘PCRE rule’: ‘combined PCRE rule generated’
}

Please return only a JSON reply, nothing additional.

At block 615, the campaign identification service invokes a language model with the prompt to obtain a combined PCRE in a response. The language model can be an open-source or closed-source LLM. Subsequent operations assume that the PCRE combining is a success and that an output of the language model indicates a combined PCRE, though the language model can output an error message, in which case no combined PCRE is obtained for consideration for the set of malicious URLs. In the event that the language model outputs an error message (e.g., due to a network/service error), the campaign identification service can retry the combined PCRE generation with the prompt up to N times (e.g., up to three additional times).

At block 617, the campaign identification service indicates the combined PCRE. The campaign identification service can write the combined PCRE to a file, generate a notification indicating the combined PCRE, store the combined PCRE (e.g., in a data structure or database), etc. to make the combined PCRE available for inline detection operations.

FIG. 6 describes example operations for combining PCREs into a unifying PCRE representing malicious URLs inferred to correspond to a malicious URL campaign. In implementations, if there are multiple error cases, the operations corresponding to blocks 605 through 611 can yield a single PCRE. In this case, the operations corresponding to block 613 and 615 can be omitted, and the campaign identification service can instead validate the single generated PCRE based on the collective sets of malicious and benign URLs with a prompt constructed similar to the example prompts given above.

### Variations

This description describes generating pooled embeddings for URLs. Implementations can generate aggregate embeddings instead of pooled embeddings. For instance, a plurality of embeddings that capture different features of the URL (e.g., the text embedding, TF-IDF embedding, and n-grams embedding described above) can be normalized and concatenated to generate an aggregate embedding rather than being input into a pooling layer to generate a pooled embedding.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

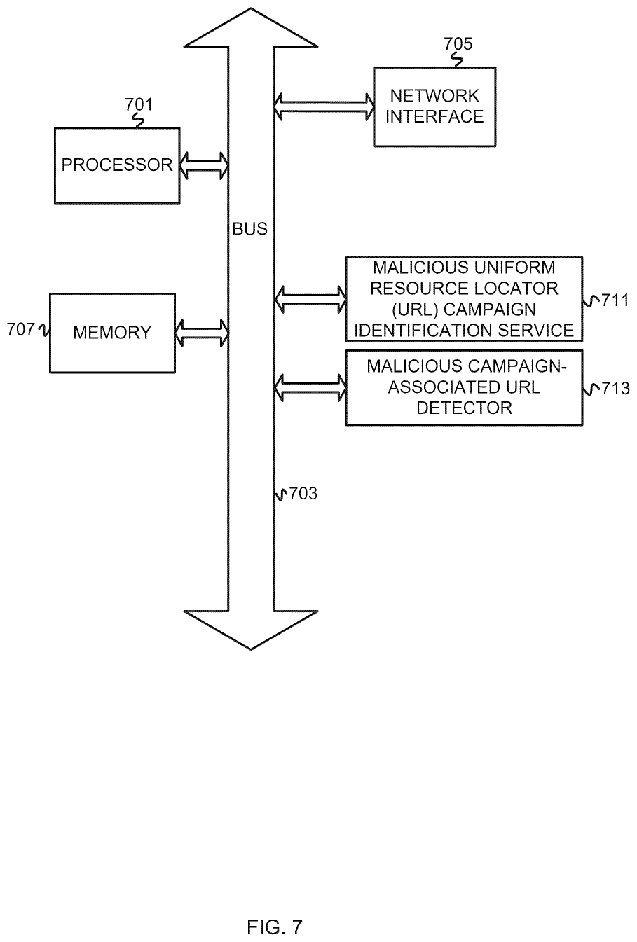

FIG. 7 depicts an example computer system with a malicious URL campaign identification service and a malicious campaign-associated URL detector. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes malicious URL campaign identification service 711 and malicious campaign-associated URL detector 713. The malicious URL campaign identification service 711 generates pooled embeddings representing known malicious URLs inferred to correspond to a malicious URL campaign and clusters the pooled embeddings into clusters, with each cluster representing an inferred malicious URL campaign. The malicious URL campaign identification service 711 generates patterns such as PCREs based on those of the known malicious URLs corresponding to each cluster and cluster embeddings representing groups of clustered malicious URLs. The malicious campaign-associated URL detector 713 determines if URLs detected in network traffic match any of the generated patterns and, if a match is found for a URL, indicates that the URL corresponds to a malicious campaign. If a pattern match is not found for the URL, the malicious campaign-associated URL detector 713 generates a pooled embedding from the URL and determines if the pooled embedding is sufficiently similar to any of the cluster embeddings; if so, the malicious campaign-associated URL detector 713 indicates that the URL corresponds to a malicious campaign. While depicted as part of the same computer system in FIG. 7 to aid in illustration, the malicious URL campaign identification service 711 and malicious campaign-associated URL detector 713 do not necessarily execute as part of the same computer system in implementations. For instance, the malicious URL campaign identification service 711 and malicious campaign-associated URL detector 713 can execute on different servers, in different respective virtual machines, etc. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
inferring malicious uniform resource locator (URL) campaigns based on pooled embeddings of malicious URLs and generating patterns to detect URLs associated with the inferred malicious URL campaigns, wherein inferring the malicious URL campaigns and generating patterns comprises,
generating a plurality of pooled embeddings based on the malicious URLs, wherein each of the plurality of pooled embeddings corresponds to one of the malicious URLs;
clustering the plurality of pooled embeddings into a plurality of clusters, wherein those of the malicious URLs represented in each of the plurality of clusters correspond to a respective one of the inferred malicious URL campaigns; and
generating a plurality of patterns based on those of the malicious URLs represented by the plurality of clusters; and
providing the plurality of patterns for inline detection of URLs related to malicious URL campaigns.

2. The method of claim 1 further comprising:
based on detecting a first URL in network traffic, determining if the first URL matches any of the plurality of patterns; and
based on determining that the first URL matches a first pattern of the plurality of patterns, blocking the network traffic.

3. The method of claim 2, further comprising:
generating a plurality of cluster embeddings, wherein each of the plurality of cluster embeddings corresponds to one of the plurality of clusters;
based on determining that the first URL does not match any of the plurality of patterns, generating a pooled embedding based on the first URL;
determining if the pooled embedding is sufficiently similar to any of the plurality of cluster embeddings; and
based on determining that the pooled embedding is sufficiently similar to a first cluster embedding of the plurality of cluster embeddings, blocking the network traffic.

4. The method of claim 1, wherein generating the plurality of pooled embeddings based on the malicious URLs comprises, for each of the malicious URLs,
generating two or more of a text embedding, a term frequency-inverse document frequency (TF-IDF) embedding, and an n-grams embedding from the malicious URL; and
pooling the two or more of the text embedding, the TF-IDF embedding, and the n-grams embedding with average pooling or max pooling to generate the corresponding one of the plurality of pooled embeddings.

5. The method of claim 1, further comprising;
retrieving a plurality of malicious URLs, wherein the plurality of malicious URLs includes the malicious URLs; and
filtering the plurality of malicious URLs based on one or more criteria for identifying URLs likely associated with a malicious URL campaign, wherein the malicious URLs are those of the plurality of malicious URLs that satisfied the one or more criteria.

6. The method of claim 5, wherein filtering the plurality of malicious URLs based on the one or more criteria comprises, for each URL of the plurality of URLs, based on at least one of determining that the URL does not include at least one of a path and a query string and determining that the URL comprises a domain name that was generated with a domain generation algorithm (DGA), filtering the URL out from the plurality of malicious URLs.

7. The method of claim 1, wherein generating the plurality of patterns comprises generating a plurality of regular expressions based on those of the malicious URLs represented by the plurality of clusters.

8. The method of claim 7, wherein generating the plurality of regular expressions comprises,
generating a prompt comprising a subset of the malicious URLs, a set of known benign URLs, and a task instruction to generate a regular expression that matches the subset of malicious URLs but does not match any of the set of known benign URLs; and
submitting the prompt to a language model, wherein a response to the prompt generated by the language model indicates a first of the plurality of regular expressions.

9. The method of claim 7, wherein generating the plurality of regular expressions comprises generating a plurality of Perl Compatible Regular Expressions (PCREs).

10. The method of claim 1, wherein clustering the plurality of pooled embeddings into the plurality of clusters comprises clustering the plurality of pooled embeddings according to a clustering algorithm.

11. One or more non-transitory machine-readable media having program code stored thereon, the program code comprising instructions to:
determine suspected malicious URL campaigns represented in a first plurality of malicious uniform resource locators (URLs) based on pooled embeddings of the plurality of malicious URLs, wherein the instructions to determine the suspected malicious URL campaigns comprise instructions to,
generate a plurality of pooled embeddings based on the first plurality of malicious URLs, wherein each of the plurality of pooled embeddings corresponds to one of the first plurality of malicious URLs; and
cluster the plurality of pooled embeddings into a plurality of clusters, wherein each cluster in the plurality of clusters correspond to one of the suspected malicious URL campaigns;
generate a set of regular expressions for malicious URL campaign detection based on those of the first plurality of malicious URLs represented by the set of clusters; and
indicate the set of regular expressions for inline detection of URLs related to the suspected malicious URL campaigns.

12. The non-transitory machine-readable media of claim 11, wherein the program code further comprises instructions to:
generate a set of cluster embeddings, wherein each of the set of cluster embeddings corresponds to one of the set of clusters; and
indicate the set of cluster embeddings with the set of regular expressions for inline detection of URLs related to malicious URL campaigns.

13. The non-transitory machine-readable media of claim 11, wherein the instructions to generate the plurality of pooled embeddings based on the plurality of malicious URLs comprise instructions to, for each malicious URL in the first plurality of malicious URLs,
generate, from the malicious URL, two or more of a text embedding, a term frequency-inverse document frequency (TF-IDF) embedding, and an n-grams embedding; and
pool the two or more of the text embedding, the TF-IDF embedding, and the n-grams embedding with average pooling or max pooling to generate the corresponding pooled embedding in the plurality of pooled embeddings.

14. The non-transitory machine-readable media of claim 11, wherein the program code further comprises instructions to filter a second plurality of malicious URLs based on one or more criteria for identifying URLs likely associated with a malicious URL campaign to obtain the first plurality of malicious URLs, wherein the first plurality of malicious URLs corresponds to those of the second plurality of malicious URLs that satisfied the one or more criteria.

15. The non-transitory machine-readable media of claim 11, wherein the instructions to generate the set of regular expressions comprise instructions to generate a set of Perl Compatible Regular Expressions (PCREs).

16. An apparatus comprising:
a processor; and
a machine-readable medium having instructions stored thereon that are executable by the processor to cause the apparatus to,
infer malicious uniform resource locator (URL) campaigns based on pooled embeddings of a plurality of malicious URLs, wherein the instructions executable by the processor to cause the apparatus to infer the malicious URL campaigns comprise instructions executable by the processor to cause the apparatus to,
generate a plurality of pooled embeddings based on the plurality of malicious URLs, wherein each of the plurality of pooled embeddings corresponds to one of the plurality of malicious URLs;
cluster the plurality of pooled embeddings into a plurality of clusters, wherein those of the plurality of malicious URLs represented in each of the plurality of clusters correspond to a respective one of the inferred malicious URL campaigns;
generate a plurality of patterns based on those of the plurality of malicious URLs represented by the plurality of clusters; and
provide the plurality of patterns for inline detection of URLs related to malicious URL campaigns.

17. The apparatus of claim 16, further comprising instructions executable by the processor to cause the apparatus to generate a plurality of cluster embeddings based on the plurality of clusters, wherein each of the plurality of cluster embeddings corresponds to one of the plurality of clusters.

18. The apparatus of claim 17, further comprising instructions executable by the processor to cause the apparatus to:
based on detection of a first URL, determine if the first URL matches any of the plurality of patterns;
based on a determination that the first URL does not match any of the plurality of patterns, generate a pooled embedding based on the first URL and determine if the pooled embedding is sufficiently similar to any of the plurality of cluster embeddings; and
indicate that the first URL is malicious based on at least one of a determination that the first URL matches one of the plurality of patterns and a determination that the pooled embedding of the first URL is sufficiently similar to one of the plurality of cluster embeddings.

19. The apparatus of claim 16, wherein the instructions executable by the processor to cause the apparatus to generate the plurality of pooled embeddings comprise instructions executable by the processor to cause the apparatus to, for each of the plurality of malicious URLs,
generate two or more of a text embedding, a term frequency-inverse document frequency (TF-IDF) embedding, and an n-grams embedding from the malicious URL; and
pool the two or more of the text embedding, the TF-IDF embedding, and the n-grams embedding with max pooling or average pooling to generate the corresponding one of the plurality of pooled embeddings.

20. The apparatus of claim 16, wherein the plurality of patterns comprises a plurality of regular expressions, and wherein the instructions executable by the processor to cause the apparatus to generate the plurality of patterns comprise instructions executable by the processor to cause the apparatus to,
generate a prompt comprising a subset of the plurality of malicious URLs, a plurality of known benign URLs, and a task instruction to generate a regular expression that matches URLs in the subset of malicious URLs but does not match any of the plurality of known benign URLs; and
submit the prompt to a language model, wherein a response to the prompt generated by the language model indicates a first of the plurality of regular expressions.
